(19) United States
(12) Patent Application Publication
(10) Pub. No.: US 2016/0218364 A1
(43) Pub. Date: Jul. 28, 2016

(54) CATHODE ACTIVE MATERIAL, POSITIVE ELECTRODE FOR LITHIUM ION SECONDARY BATTERY, AND LITHIUM ION SECONDARY BATTERY

(71) Applicant: Asahi Glass Company, Limited, Chiyoda-ku (JP)

(72) Inventors: Tomohiro Sakai, Chiyoda-ku (JP); Tsubasa Takasugi, Chiyoda-ku (JP)

(73) Assignee: Asahi Glass Company, Limited, Chiyoda-ku (JP)

(21) Appl. No.: 14/982,344

(22) Filed: Dec. 29, 2015

(30) Foreign Application Priority Data
Jan. 23, 2015 (JP) 2015-011027

(51) Int. Cl. H01M 4/505; H01M 10/0525

(52) U.S. Cl. CPC H01M 4/505; H01M 10/0525; H01M 2004/028

(57) ABSTRACT

To provide a lithium rich cathode active material capable of obtaining a lithium ion secondary battery excellent in the discharge capacity and cycle characteristics; a positive electrode for such a lithium ion secondary battery; and such a lithium ion secondary battery. The cathode active material comprises a lithium-containing composite oxide, wherein the lithium-containing composite oxide is represented by aLi(Li_{1/3}Mn_{2/3})O₂·(1−a)LiMO₂ (wherein M is at least one transition metal element selected from the group consisting of Ni, Co and Mn, and a is more than 0 and less than 1), and in an X-ray diffraction pattern of the lithium-containing composite oxide, the integral breadth of a peak of (020) plane assigned to a crystal structure with space group C2/m is at most 0.55 deg.

### FIELD OF INVENTION

The present invention relates to a cathode active material, a positive electrode for a lithium ion secondary battery, and a lithium ion secondary battery.

### BACKGROUND OF INVENTION

As a cathode active material contained in a positive electrode of a lithium ion secondary battery, a lithium-containing composite oxide, particularly LiCoO₂, is well known. However, in recent years, for a lithium ion secondary battery for portable electronic instruments or for vehicles, downsizing and weight saving are required, and a further improvement in the discharge capacity of a lithium ion secondary battery per unit mass of the cathode active material (hereinafter sometimes referred to simply as the discharge capacity) is required.

As a cathode active material which may be able to further increase the discharge capacity of a lithium ion secondary battery, a cathode active material having high Li and Mn contents i.e. a so-called lithium rich cathode active material has attracted attention. However, a lithium ion secondary battery using such a lithium rich cathode active material has a problem such that the characteristics to maintain the charge and discharge capacity at the time of repeating a charge and discharge cycle (hereinafter referred to as the cycle characteristics) tend to decrease.

As a lithium rich cathode active material capable of obtaining a lithium secondary battery excellent in the discharge capacity and cycle characteristics, the following one has been proposed.

A cathode active material consisting of a lithium-containing composite oxide having a crystal structure with space group R-3m and a crystal structure with space group C2/m (lithium excess phase), wherein the lithium-containing composite oxide contains Li, either one or both of Ni and Co, and Mn, the ratio of the molar amount of Mn to the total molar amount (X) of Ni, Co and Mn (i.e. Mn/X) is at least 0.55, and in the X-ray diffraction pattern, the ratio of the integrated intensity (1020) of a peak of (020) plane assigned to a crystal structure with space group C2/m to the integrated intensity (I₀₀₃) of a peak of (003) plane assigned to a crystal structure with space group R-3m (i.e. I₀₂₀/I₀₀₃) is from 0.02 to 0.5, and it contains B (boron) in an amount of from 0.001 to 3 mass % (Patent Document 1).

It is disclosed that in the cathode active material, B is present at the surface of the cathode active material, whereby contact of the cathode active material and the electrolyte is suppressed, and the cycle characteristics of the lithium ion secondary battery are improved. However, even by the lithium ion secondary battery using such a cathode active material, the cycle characteristics are not yet at a sufficiently satisfactory level.

### PRIOR ART DOCUMENT

### Patent Document

Patent Document 1: JP-A-2011-096650

### SUMMARY OF INVENTION

### Technical Problem

It is an object of the present invention to provide a lithium rich cathode active material capable of obtaining a lithium ion secondary battery excellent in the discharge capacity and cycle characteristics; a positive electrode for a lithium ion secondary battery, capable of obtaining a lithium ion secondary battery excellent in the discharge capacity and cycle characteristics; and a lithium ion secondary battery excellent in the discharge capacity and cycle characteristics.

### Solution to Problem

The present invention provides the following embodiments.

[1] A cathode active material comprising a lithium-containing composite oxide, wherein the lithium-containing composite oxide is represented by aLi(Li_{1/3}Mn_{2/3})O₂ (1−a)LiMO₂ (wherein M is at least one transition metal element selected from Ni, Co and Mn, and a is more than 0 and less than 1), and in an X-ray diffraction pattern of the lithium-containing composite oxide, the integral breadth of a peak of (020) plane assigned to a crystal structure with space group C2/m is at most 0.55 deg.

[2] The cathode active material according to [1], wherein in the lithium-containing composite oxide, the ratio of the molar amount of Ni to the total molar amount (X) of Ni, Co and Mn (i.e. Ni/X) is from 0.15 to 0.45, the ratio of the molar amount of Co thereto (i.e. Co/X) is from 0 to 0.09, and the ratio of the molar amount of Mn thereto (i.e. Mn/X) is from 0.55 to 0.85.

[3] The cathode active material according to [1] or [2], wherein the specific surface area of the cathode active material is from 0.5 to 4 m²/g.

[4] The cathode active material according to any one of [1] to [3], wherein D₅₀ of the cathode active material is from 3 to 15 μm.

[5] The cathode active material according to any one of [1] to [4], wherein in an X-ray diffraction pattern of the lithium-containing composite oxide, the crystallite diameter obtained by the Scherrer equation from a peak of (003) plane assigned to a crystal structure with space group R-3m is from 30 to 120 nm.

[6] The cathode active material according to any one of [1] to [5], wherein in an X-ray diffraction pattern of the lithium-containing composite oxide, the crystallite diameter obtained by the Scherrer equation from a peak of (110) plane assigned to a crystal structure with space group R-3m is from 10 to 80 nm.

[7] A positive electrode for a lithium ion secondary battery, which comprises the cathode active material as defined in any one of [1] to [6], an electrically conductive material and a binder.

[8] A lithium ion secondary battery, which comprises the positive electrode for a lithium ion secondary battery as defined in [7], a negative electrode and a non-aqueous electrolyte.

### Advantageous Effects of Invention

By the cathode active material of the present invention, it is possible to obtain a lithium ion secondary battery excellent in the discharge capacity and cycle characteristics.

By the positive electrode for a lithium ion secondary battery of the present invention, it is possible to obtain a lithium ion secondary battery excellent in the discharge capacity and cycle characteristics.

The lithium ion secondary battery of the present invention is excellent in the discharge capacity and cycle characteristics.

### BRIEF DESCRIPTION OF DRAWINGS

FIG. 1 is a graph showing X-ray diffraction patterns of the cathode active materials in Ex. 1, 5, 7 and 11.

FIG. 2 is a graph having a part of FIG. 1 enlarged.

FIG. 3 is a graph showing a relation between the integral breadth (W₀₂₀) of a peak of (020) plane assigned to a crystal structure with space group C2/m in an X-ray diffraction pattern of a lithium-containing composite oxide and the cycle characteristics.

### DETAILED DESCRIPTION OF INVENTION

The following definitions of terms are applied to this specification including Claims.

The “integral breadth” means the width of a rectangle with the same area and height as a specific peak in an X-ray diffraction pattern.

The “specific surface area” is a value measured by a BET (Brunauer, Emmet, Teller) method. In the measurement of the specific surface area, nitrogen gas is used as an absorption gas.

The “D₅₀” is a particle size at a point of 50% on an accumulative volume distribution curve which is drawn by obtaining the particle size distribution on the volume basis and taking the whole to be 100%, that is, a volume-based accumulative 50% size.

The “particle size distribution” is obtained from the frequency distribution and accumulative volume distribution curve measured by means of a laser scattering particle size distribution measuring apparatus (for example, a laser diffraction/scattering type particle size distribution measuring apparatus). The measurement is carried out by sufficiently dispersing the powder in an aqueous medium by e.g. ultrasonic treatment.

The “crystallite diameter” is obtained by the following Scherrer equation from a diffraction angle 2θ(deg) and half-value width B(rad)of a specific peak in an X-ray diffraction pattern.

D_{abc}=(0.9λ)/(Bcosθ)

wherein D_{abc} is a crystallite diameter of (abc) plane, and A is the wavelength of X-rays.

The expression “Li” means a Li element, not a Li metal simple substance, unless otherwise specified. The same applies to expressions of other elements such as Ni, Co, Mn, etc.

The composition analysis of a lithium-containing composite oxide is carried out by inductively-coupled plasma spectrometry (hereinafter referred to as ICP). Further, the ratio of elements in a lithium-containing composite oxide is a value with respect to the lithium-containing composite oxide before initial charging (also called activation treatment).

Cathode active material

The cathode active material of the present invention (hereinafter referred to as the present active material) comprises a lithium-containing composite oxide (1) (hereinafter referred to as a composite oxide (1)). The present active material preferably comprises secondary particles having primary particles of the composite oxide (1) agglomerated. Further, the present active material may be in such a form that the surface of the composite oxide (1) is covered with a covering material (2).

The composite oxide (1) is represented by a formula aLi(Li_{1/3}Mn_{2/3})O₂·(1-a)LiMO₂ (wherein M is at least one transition metal element selected from Ni, Co and Mn, and a is more than 0 and less than 1).

The present active material comprises the composite oxide (1), whereby the discharge capacity of a lithium ion secondary battery using the present active material can be made high.

In the above formula of the composite oxide (1), M is at least one transition metal element selected from Ni, Co and Mn. With a view to further increasing the discharge capacity of the lithium ion secondary battery, M preferably contains Ni and Mn, and more preferably contains Ni, Co and Mn.

In the composite oxide (1), the ratio of the molar amount of Ni to the total molar amount (X) of Ni, Co and Mn (i.e. Ni/X) is preferably from 0.15 to 0.45. When Ni/X is from 0.15 to 0.45, the discharge capacity and discharge voltage of the lithium ion secondary battery can be made higher. Further, with a view to further increasing the discharge voltage of the lithium ion secondary battery, Ni/X is more preferably from 0.15 to 0.40, further preferably from 0.15 to 0.35.

In the composite oxide (1), the ratio of the molar amount of Co to the total molar amount (X) of Ni, Co and Mn (i.e. Co/X) is preferably from 0 to 0.09. When Co/X is from 0 to 0.09, the rate characteristics of the lithium ion secondary battery can be made higher. Further, with a view to further improving the cycle characteristics of the lithium ion secondary battery, Co/X is more preferably from 0 to 0.05, further preferably from 0 to 0.02.

In the composite oxide (1), the ratio of the molar amount of Mn to the total molar amount (X) of Ni, Co and Mn (i.e. Mn/X) is preferably from 0.55 to 0.85. When Mn/X is from 0.55 to 0.85, the discharge voltage and discharge capacity of the lithium ion secondary battery can be made higher. Further, with a view to further increasing the discharge voltage of the lithium ion secondary battery, the upper limit for Mn/X is more preferably 0.8. With a view to further increasing the discharge capacity of the lithium ion secondary battery, the lower limit for Mn/X is more preferably 0.6.

In the composite oxide (1), the ratio of the molar amount of Li to the total molar amount (X) of Ni, Co and Mn (i.e. Li/X) is preferably from 1.1 to 1.8. When Li/X is from 1.1 to 1.8, the discharge capacity of the lithium ion secondary battery can be made higher. Li/X is more preferably from 1.1 to 1.7, further preferably from 1.2 to 1.7.

The composite oxide (1) may contain other elements other than Li, Ni, Co and Mn, as the case requires. Such other elements may, for example, be P, Mg, Ca, Ba, Sr, Al, Cr, Fe, Ti, Zr, Y, Nb, Mo, Ta, W, Ce, La, etc. With a view to further increasing the discharge capacity of the lithium ion secondary battery, preferred as such other elements, is at least one member selected from the group consisting of Mg, Al, Cr, Fe, Ti and Zr.

In the above formula of the composite oxide (1), a is more than 0 and less than 1. When a is more than 0, the discharge capacity of the lithium ion secondary battery having the composite oxide (1) can be made higher. When a is less than 1, the discharge voltage of the lithium ion secondary battery having the composite oxide (1) can be made higher. With a view to further increasing the discharge capacity of the lithium ion secondary battery, a is preferably at least 0.1, more preferably at least 0.2. Further, with a view to further increasing the discharge voltage of the lithium ion secondary battery, a is preferably at most 0.78, more preferably at most 0.75.

The composite oxide (1) is preferably one represented by a formula aLi(Li_{1/3}Mn_{2/3})O₂·(1−a)LiNi_{α}Co_{β}Mn_{γ}O₂ (wherein α is from 0.5 to 0.833, β is from 0 to 0.3, and γ is from 0.167 to 0.5).

The composite oxide (1) is a solid solution of Li(Li_{1/3}Mn_{2/3})O₂ (lithium excess phase) having a layered rock salt crystal structure with space group C2/m and LiMO₂ having a layered rock salt crystal structure with space group R-3m. By an X-ray diffraction measurement, it can be confirmed that the solid solution type composite oxide (1) has such crystal structures.

The X-ray diffraction measurement is carried out by the method and conditions as disclosed in Examples. The peak of (003) plane assigned to the crystal structure with space group R-3m is a peak which appears at 2θ=18 to 20 deg. The peak of (020) plane of the crystal structure with space group C2/m is a peak which appears at 2θ=20 to 22 deg. The peak of (110) plane assigned to the crystal structure with space group

R-3m is a peak which appears at 2θ=64 to 66 deg.

The composite oxide (1) of the present active material has, in the X-ray diffraction pattern, an integral breadth (W₀₂₀) of at most 0.55 deg, of a peak of (020) plane assigned to a crystal structure with space group C2/m, whereby the cycle characteristics of the lithium ion secondary battery are excellent even when a charge and discharge cycle is repeated.

As a result of a study about the crystal structure of the composite oxide (1), the present inventors have found that when W₀₂₀ is made to be at most 0.55 deg, the crystallinity of Li(Li_{1/3}Mn_{2/3})O₂ can be made sufficiently high to be used as a cathode active material, i.e. the crystal domain of Li(Li_{1/3}Mn_{2/3})O₂ can be made sufficiently large, and the strain of crystal can be made sufficiently small. Here, in the composite oxide (1), the crystal of LiMO₂ is known to have high crystallinity. Accordingly, when W₀₂₀ is at most 0.55 deg, the crystallinity of the entire solid solution type composite oxide (1) will be high. It is considered that in the composite oxide having high crystallinity, the crystal structure will be stably maintained and the number of sites capable of desorbing and absorbing Li ions will be maintained, even when a charge and discharge cycle is repeated, whereby the cycle characteristics will be good.

W₀₂₀ of the composite oxide (1) is preferably at most 0.53 deg, more preferably at most 0.051 deg. The lower limit value of W₀₂₀ of the composite oxide (1) is the measurement limit by the X-ray diffraction apparatus, preferably at least 0.08 deg. Here, 0.08 deg is the lower limit value calculated from a standard sample 660b for X-ray diffraction.

In the X-ray diffraction pattern of the composite oxide (1), the ratio of the height (H₀₂₀) of a peak of (020) plane assigned to a crystal structure with space group C2/m to the height (H₀₀₃) of a peak of (003) plane assigned to a crystal structure with space group R-3m (i.e. H₀₂₀/H₀₀₃) is preferably at least 0.03, more preferably at least 0.031, further preferably at least 0.032. When compared at the same integrated intensity, the one having a higher peak height has a narrower peak width. Accordingly, H₀₂₀ being relatively high as based on H₀₀₃, indicates that the domain of Li(Li_{1/3}Mn_{2/3})O₂ has grown, and the crystallinity is high. Thus, it is possible to obtain a cathode active material whereby the cycle characteristics of the lithium ion secondary battery will become still better.

H₀₂₀/H₀₀₃ is preferably at most 0.07, whereby the rate characteristics of the lithium ion secondary battery can easily be made good.

In a crystallite having a layered rock salt crystal structure with space group R-3m, during charging and discharging, each Li diffuses in the a-b axis direction, and getting in and out of Li occurs at ends of the crystallite. The c-axis direction of the crystallite is the lamination direction, and in a shape being long in the c-axis, the number of ends where Li can get in and out, increases as compared with other crystallites having the same volume. The crystallite diameter in the a-b axis direction is a crystallite diameter (D₁₁₀) obtained by the Scheller equation from a peak of (110) plane assigned to a crystal structure with space group R-3m in the X-ray diffraction pattern of the composite oxide (1). The crystallite diameter in the c-axis direction is a crystallite diameter (D₀₀₃) obtained by the Scheller equation from a peak of (003) plane of space group R-3m in the X-ray diffraction pattern of the composite oxide (1).

In the composite oxide (1), D₀₀₃ is preferably from 30 to 120 nm, more preferably from 40 to 110 nm, further preferably from 50 to 110 nm. When D₀₀₃ is at least the above lower limit value, the cycle characteristics of the lithium ion secondary battery can easily be made good. When D₀₀₃ is at most the above upper limit value, the discharge capacity of the lithium ion secondary battery can easily be made high.

In the composite oxide (1), D₁₁₀ is preferably from 10 to 80 nm, more preferably from 15 to 80 nm, further preferably from 20 to 70 nm. When D₁₁₀ is at least the above lower limit value, the stability of the crystal structure will be improved. When D₁₁₀ is at most the above upper limit value, the cycle characteristics of the lithium ion secondary battery can easily be made good.

In the present active material, if the composite oxide (1) has a covering (2) on its surface, the frequency in contact of the composite oxide (1) and the electrolyte decreases. As a result, it is possible to reduce elution, into the electrolyte, of transition metal elements such as Mn, etc. in the composite oxide (1) during the charge and discharge cycles, whereby the cycle characteristics of the lithium ion secondary battery can be made better.

As the covering (2), an Al compound (such as Al₂O₃, AlOOH or Al(OH)₂) is preferred, since it is thereby possible to make the cycle characteristics of the lithium ion secondary battery better without lowering other battery characteristics.

The covering (2) may be present on the surface of the composite oxide (1), and it may be present over the entire surface of the composite oxide (1) or may be present on a part of the composite oxide (1). Further, it may be present on the surface of primary particles of the composite oxide (1) or may be present on the surface of secondary particles thereof. The presence of the covering (2) can be confirmed by a contrast of a reflection image of a scanning electron microscope (SEM) or by an electron probe microanalyzer (EPMA).

The specific surface area of the present active material is preferably from 0.5 to 4 m²/g, more preferably from 0.5 to 3 m²/g, further preferably from 0.7 to 2.8 m²/g. When the specific surface area is at least 0.5 m²/g, the discharge capacity of the lithium ion secondary battery can be made higher. When the specific surface area is at most 4 m²/g, the cycle characteristics of the lithium ion secondary battery can be made better.

The specific surface area of the present active material is measured by the method disclosed in Examples.

D₅₀ of the present active material is preferably from 3 to 15 μm, more preferably from 3 to 12 μm, further preferably from 4 to 10 μm. When D₅₀ is from 3 to 15 μm, the discharge capacity of the lithium ion secondary battery can easily be made high.

### Process for Producing Cathode Active Material

The present active material may be produced, for example, by a method comprising the following steps (a) to (c).

(a) A step of obtaining a precursor containing transition metal elements of Mn and at least one member selected from Ni and Co.

(b) A step of mixing the precursor and a lithium compound, and the obtained mixture is fired to obtain a composite oxide (1).

(c) As the case requires, a step of forming a covering (2) on the surface of the composite oxide (1).

### Step (a)

The precursor may be prepared, for example, by a method of obtaining a compound containing transition metal elements of Mn and at least one member selected from Ni and Co, by a coprecipitation method.

The coprecipitation method may, for example, be an alkali coprecipitation method or a carbonate coprecipitation method.

The alkali coprecipitation method is a method wherein an aqueous metal salt solution containing transition metal elements of Mn and at least one member selected from Ni and Co, and a pH adjusting liquid containing a strong alkali, are continuously supplied to a reaction tank and mixed, and while maintaining the pH in the mixture to be constant, hydroxides containing transition metal elements of Mn and at least one member selected from Ni and Co, are precipitated.

The carbonate coprecipitation method is a method wherein an aqueous metal salt solution containing transition metal elements of Mn and at least one member selected from Ni and Co, and an aqueous carbonate solution containing an alkali metal, are continuously supplied to a reaction tank and mixed, and in the mixture, carbonates containing transition metal elements of Mn and at least one member selected from Ni and Co, are precipitated.

As the coprecipitation method, the alkali coprecipitation method is preferred in that the cycle characteristics of the lithium ion secondary battery can thereby easily be made good.

Now, the precipitation method for hydroxides will be described in detail with reference to the alkali coprecipitation method.

The metal salts may, for example, be nitrates, acetates, chlorides or sulfates of the respective transition metal elements, and sulfates are preferred in that the material costs are relatively inexpensive and excellent battery characteristics are thereby obtainable. As the metal salts, a sulfate of Ni, a sulfate of Mn and a sulfate of Co are more preferred.

The sulfate of Ni may, for example, be nickel(II) sulfate hexahydrate, nickel(II) sulfate heptahydrate or nickel(II) ammonium sulfate hexahydrate.

The sulfate of Co may, for example, be cobalt(II) sulfate heptahydrate or cobalt(II) ammonium sulfate hexahydrate.

The sulfate of Mn may, for example, be manganese(II) sulfate pentahydrate or manganese(II) ammonium sulfate hexahydrate.

The ratio of Ni, Co and Mn in the aqueous metal salt solution is adjusted to be the same as the ratio of Ni, Co and Mn contained in the finally obtainable composite oxide (1).

The total concentration of Mn and at least one member selected from Ni and Co in the aqueous metal salt solution is preferably from 0.1 to 3 mol/kg, more preferably from 0.5 to 2.5 mol/kg. When the total concentration of Mn and at least one member selected from Ni and Co, is at least the above lower limit value, the productivity will be excellent. When the total concentration of Mn and at least one member selected from Ni and Co, is at most the above upper limit value, the metal salts can be sufficiently dissolved in water.

The aqueous metal salt solution may contain an aqueous medium other than water.

The aqueous medium other than water, may, for example, be methanol, ethanol, 1-propanol, 2-propanol, ethylene glycol, propylene glycol, diethylene glycol, dipropylene glycol, polyethylene glycol, butanediol or glycerine. The proportion of the aqueous medium other than water is preferably from 0 to 20 parts by mass, more preferably from 0 to 10 parts by mass, particularly preferably from 0 to 1 part by mass, per 100 parts by mass of water, from the viewpoint of safety, environmental aspect, handling efficiency and costs.

The pH adjusting liquid is preferably an aqueous solution containing a strong alkali.

The strong alkali is preferably at least one member selected from the group consisting of sodium hydroxide, potassium hydroxide and lithium hydroxide.

To the mixed liquid, a complexing agent (an aqueous ammonium solution or an aqueous ammonium sulfate solution) may be added to adjust the solubility of Mn ions and at least one member selected from Ni ions and Co ions.

The aqueous metal salt solution and the pH adjusting liquid are preferably mixed with stirring in the reaction tank.

The stirring device may, for example, be a three-one motor, and the stirring blades may, for example, be anchor-type, propeller-type or paddle-type.

The reaction temperature is preferably from 20 to 80° C., more preferably from 25 to 60° C., with a view to accelerating the reaction.

Mixing of the aqueous metal salt solution and the pH adjusting liquid is preferably conducted in a nitrogen atmosphere or in an argon atmosphere, with a view to preventing oxidation of the hydroxides, and it is particularly preferably conducted in a nitrogen atmosphere from the viewpoint of costs.

During the mixing of the aqueous metal salt solution and the pH adjusting liquid, it is preferred to maintain the pH in the reaction tank to be a pH set within a range of from 10 to 12, with a view to letting the coprecipitation reaction proceed properly. When the mixing is conducted at a pH of at least 10, coprecipitates are deemed to be hydroxides.

As the method for precipitating hydroxides, two types may be mentioned, i.e. a method (hereinafter referred to as a concentration method) of carrying out the precipitation reaction while concentrating hydroxides by withdrawing the mixed liquid in the reaction tank through a filter (e.g. a filter cloth), and a method (hereinafter referred to as an overflow method) of carrying out the precipitation reaction while maintaining the concentration of hydroxides to be low by withdrawing the mixed liquid in the reaction tank, together with the hydroxides, without using a filter. The concentration method is preferred, since it is thereby possible to narrow the particle size distribution.

The precursor is preferably washed to remove impurities. The washing method may, for example, be a method of repeating pressure filtration and dispersion into distilled water. Such washing is preferably repeated until the electrical conductivity of the filtrate or the supernatant at the time when the precursor is dispersed in distilled water, becomes to be at most 50 mS/m, more preferably repeated until the electrical conductivity becomes to be at most 20 mS/m.

After the washing, the precursor may be dried as the case requires.

The drying temperature is preferably from 60 to 200° C., more preferably from 80 to 130° C. When the drying temperature is at least the above lower limit value, the drying time can be shortened. When the drying temperature is at most the above upper limit value, it is possible to prevent the progress of oxidation of the precursor.

The drying time may be properly set depending upon the amount of the precursor and is preferably from 1 to 300 hours, more preferably from 5 to 120 hours.

The specific surface area of the precursor is preferably from 3 to 60 m²/g, more preferably from 5 to 40 m²/g. When the specific surface area of the precursor is within the above range, the specific surface area of the present active material can be easily controlled to be within a preferred range. Here, the specific surface area of the precursor is a value measured after the precursor is dried at 120° C. for 15 hours.

D₅₀ of the precursor is preferably from 3 to 15.5 μm, more preferably from 4 to 12.5 μm, further preferably from 3 to 10.5 μm. When D₅₀ of the precursor is within the above range, D₅₀ of the present active material can be easily controlled to be within a preferred range.

### Step (b)

The precursor and a lithium compound are mixed and fired, whereby a composite oxide (1) will be formed.

The lithium compound is preferably one member selected from the group consisting of lithium carbonate, lithium hydroxide and lithium nitrate. Lithium carbonate is more preferred from the viewpoint of handling efficiency in the production process.

The method for mixing the precursor and the lithium compound may, for example, be a method of using a rocking mixer, a Nauta mixer, a spiral mixer, a cutter mill or a V mixer.

The ratio of the molar amount of Li contained in the lithium compound to the total molar amount (X₂) of Ni, Co and Mn contained in the precursor (i.e. Li/X₂) is preferably from 1.1 to 1.8, more preferably from 1.1 to 1.7, further preferably from 1.2 to 1.7. When Li/X₂ is within the above range, Li/X contained in the composite oxide (1) can be made to be within a desired range, and the discharge capacity of the lithium ion secondary battery can be made high.

The firing apparatus may, for example, be an electric furnace, a continuous firing furnace or a rotary kiln.

During the firing, the precursor is oxidized, and therefore, the firing is preferably conducted in the atmospheric air, and it is particularly preferred to carry out the firing while supplying air.

The supply rate of air is preferably from 10 to 200 mL/min., more preferably from 40 to 150 mL/min., per 1L of the inner volume of the furnace.

By supplying air during the firing, metal elements contained in the precursor will be sufficiently oxidized. As a result, it is possible to obtain a composite oxide (1) having a high crystallinity and having a crystal structure with space group C2/m and a crystal structure with space group R-3m.

The firing temperature is from 500 to 1,000° C. The firing temperature is preferably at least 860° C., more preferably at least 875° C., further preferably at least 890° C. When the firing temperature is at least 860° C., the domain of Li(Li_{1/3}Mn_{2/3})O₂ tends to easily grow, and it is possible to form a composite oxide (1) having a W₀₂₀ of at most 0.55 deg. Further, the firing temperature is preferably at most 1,100° C., more preferably at most 1,080° C., further preferably at most 1,050° C. When the firing temperature is at most 1,100° C., volatilization of Li can be prevented in the firing process, and it is possible to obtain a composite oxide (1) corresponding to the charged ratio with respect to Li.

The firing time is preferably from 4 to 40 hours, more preferably from 4 to 20 hours.

The firing may be one-stage firing or two-stage firing i.e. temporary firing followed by main firing. The two-stage firing is preferred since Li thereby tends to be readily uniformly dispersed in the composite oxide (1). In the case of conducting the two-stage firing, the main firing is carried out at a temperature within the above-mentioned firing temperature range. And the temperature for the temporary firing is preferably from 400 to 700° C., more preferably from 500 to 650° C.

### Step (c)

The method for forming the covering (2) may, for example, be a powder mixing method, a gas phase method, a spray coating method or a dipping method. The following description will be made with reference to a case where the covering (2) is an Al compound.

The powder mixing method is a method of mixing the composite oxide (1) and the Al compound, followed by heating. The gas phase method is a method of gasifying an organic compound containing Al, such as aluminum ethoxide, aluminum isopropoxide or aluminum acetylacetonate, and letting the organic compound be in contact with the surface of the composite oxide (1) and reacted. The spray coating method is a method of spraying a solution containing Al to the composite oxide (1), followed by heating.

Otherwise, a covering (2) containing an Al compound may be formed on the surface of the composite oxide (1) by contacting to the composite oxide (1), e.g. by a spray coating method, an aqueous solution having dissolved in a solvent, a water-soluble Al compound (such as aluminum acetate, aluminum oxalate, aluminum citrate, aluminum lactate, basic aluminum lactate or aluminum nitrate) to form an Al compound, followed by heating to remove the solvent.

### Function and Mechanism

The above-described present active material is a so-called lithium rich cathode active material containing a lithium-containing composite oxide represented by the formula aLi(Li_{1/3}Mn_{2/3})O₂·(1-a)LiMO₂, whereby it is possible to obtain a lithium ion secondary battery excellent in the discharge capacity. Further, W₀₂₀ of the lithium-containing composite oxide contained in the above-described present active material is at most 0.55 deg, whereby the crystallinity of Li(Li_{1/3}Mn_{2/3})O₂ is high, and the stability of the crystal structure of the entire lithium-containing composite oxide is also high. As a result, even when a charge and discharge cycle is repeated, a change in the crystal structure of the lithium-containing composite oxide is less, and it is possible to obtain a lithium ion secondary battery excellent in the cycle characteristics.

### Positive Electrode for Lithium Ion Secondary Battery

The positive electrode for a lithium ion secondary battery of the present invention (hereinafter referred to as the present positive electrode) contains the present active material. Specifically, it has a cathode active material layer comprising the present active material, an electrically conductive material and a binder, formed on a positive electrode current collector.

As the electrically conductive material, carbon black (such as acetylene black or Ketjen black), graphite, vapor-grown carbon fibers or carbon nanotubes may, for example, be mentioned.

As the binder, a fluorinated resin (such as polyvinylidene fluoride or polytetrafluoroethylene), a polyolefin (such as polyethylene or polypropylene), a polymer or copolymer having unsaturated bonds (such as a styrene/butadiene rubber, an isoprene rubber or a butadiene rubber) or an acrylic polymer or copolymer (such as an acrylic copolymer or a methacrylic copolymer) may, for example, be mentioned.

As the positive electrode current collector, an aluminum foil or a stainless steel foil may, for example, be mentioned.

The present positive electrode may be produced, for example, by the following method.

The present active material, the electrically conductive material and the binder are dissolved or dispersed in a medium to obtain a slurry. The obtained slurry is applied to the positive electrode current collector, and the medium is removed e.g. by drying to form a layer of the cathode active material. As the case requires, the layer of the cathode active material may be pressed e.g. by roll pressing. The present positive electrode is obtained in such a manner.

Otherwise, the present active material, the electrically conductive material and the binder are kneaded with a medium to obtain a kneaded product. The obtained kneaded product is pressed on the positive electrode current collector to obtain the present positive electrode.

### Function and Mechanism

The above-described present positive electrode contains a so-called lithium rich cathode active material, whereby it is possible to obtain a lithium ion secondary battery excellent in the discharge capacity. Further, in the above-described present positive electrode, W₀₂₀ of the lithium-containing composite oxide contained in the cathode active material is at most 0.55 deg, i.e. it contains the cathode active material wherein the crystallinity of Li(Li_{1/3}Mn_{2/3})O₂ is high, and the stability of the crystal structure of the entire lithium-containing composite oxide is also high, whereby, even when a charge and discharge cycle is repeated, a change in the crystal structure of the lithium-containing composite oxide is less, and it is possible to obtain a lithium ion secondary battery excellent in the cycle characteristics.

### Lithium Ion Secondary Battery

The lithium ion secondary battery of the present invention (hereinafter referred to as the present battery) has the present positive electrode. Specifically, it comprises the present positive electrode, a negative electrode and a non-aqueous electrolyte.

The negative electrode contains an anode active material. Specifically, it has an anode active material layer containing an anode active material and as the case requires an electrically conductive material and a binder, formed on a negative electrode current collector.

The anode active material may be any material so long as it is capable of absorbing and desorbing lithium ions at a relatively low potential. The anode active material may, for example, be a lithium metal, a lithium alloy, a lithium compound, a carbon material, an oxide composed mainly of a metal in Group 14 of the periodic table, an oxide composed mainly of a metal in Group 15 of the periodic table, a carbon compound, a silicon carbide compound, a silicon oxide compound, titanium sulfide or a boron carbide compound.

The carbon material as the anode active material may, for example, be non-graphitized carbon, artificial graphite, natural graphite, thermally decomposed carbon, cokes (such as pitch coke, needle coke or petroleum coke), graphites, glassy carbons, an organic polymer compound fired product (product obtained by firing and carbonizing a phenol resin, a furan resin or the like at an appropriate temperature), carbon fibers, activated carbon or carbon blacks.

The metal in Group 14 of the periodic table to be used as the anode active material may be Si or Sn, and is preferably Si.

As another anode active material, an oxide such as iron oxide, ruthenium oxide, molybdenum oxide, tungsten oxide, titanium oxide or tin oxide, or a nitride may, for example, be mentioned.

As the electrically conductive material and the binder for the negative electrode, the same ones as for the positive electrode may be used.

As the negative electrode current collector, a metal foil such as a nickel foil or a copper foil may be mentioned.

The negative electrode may be produced, for example, by the following method.

The anode active material, the electrically conductive material and the binder are dissolved or dispersed in a medium to obtain a slurry. The obtained slurry is applied to the negative electrode current collector, and the medium is removed e.g. by drying, followed by pressing to obtain the negative electrode.

The non-aqueous electrolyte may, for example, be a non-aqueous electrolytic solution having an electrolyte salt dissolved in an organic solvent; an inorganic solid electrolyte; or a solid or gelled polymer electrolyte in which an electrolyte salt is mixed or dissolved.

The organic solvent may be an organic solvent known for a non-aqueous electrolytic solution. It may, for example, be specifically propylene carbonate, ethylene carbonate, diethyl carbonate, dimethyl carbonate, 1,2-dimethoxyethane, 1,2-diethoxyethane, γ-butyrolactone, diethyl ether, sulfolane, methyl sulfolane, acetonitrile, an acetic acid ester, a butyric acid ester or a propionic acid ester. In view of the voltage stability, preferred is a cyclic carbonate (such as propylene carbonate) or a chain-structured carbonate (such as dim ethyl carbonate or diethyl carbonate). Such organic solvents may be used alone or in combination of two or more.

As the inorganic solid electrolyte, a material having lithium ion conductivity may be used.

The inorganic solid electrolyte may, for example, be lithium nitride or lithium iodide.

As the polymer to be used for the solid polymer electrolyte, an ether polymer compound (such as polyethylene oxide or its crosslinked product), a polymethacrylate ester polymer compound or an acrylate polymer compound may, for example, be mentioned. Such polymer compounds may be used alone or in combination of two or more.

As the polymer to be used for the gelled polymer electrolyte, a fluorinated polymer compound (such as polyvinylidene fluoride or a vinylidene fluoride/hexafluoropropylene copolymer), polyacrylonitrile, an acrylonitrile copolymer or an ether polymer compound (such as polyethylene oxide or its crosslinked product) may, for example, be mentioned. As a monomer to be copolymerized to obtain the copolymer, polypropylene oxide, methyl methacrylate, butyl methacrylate, methyl acrylate or butyl acrylate may, for example, be mentioned.

The polymer compound is preferably a fluorinated polymer compound in view of the stability against the redox reaction.

As the electrolyte salt, any one of those commonly used for a lithium ion secondary battery may be used. The electrolyte salt may, for example, be LiCIO₄, LiPF₆, LiBF₄ or CH₃SO₃Li.

Between the positive electrode and the negative electrode, a separator may be interposed so as to prevent short-circuiting. As the separator, a porous film may be mentioned. The porous film is used as impregnated with the non-aqueous electrolytic solution. Further, the porous film impregnated with the non-aqueous electrolytic solution, followed by gelation, may be used as a gelled electrolyte.

As a material of a battery exterior package, nickel-plated iron, stainless steel, aluminum or its alloy, nickel, titanium, a resin material or a film material may, for example, be mentioned.

The shape of the lithium ion secondary battery may, for example, be a coin-shape, a sheet-form (film-form), a folded shape, a wound cylinder with bottom, or a button shape, and is suitably selected depending upon the intended use. (Function and mechanism)

The above-described present battery has the present positive electrode, whereby it is excellent in the discharge capacity and cycle characteristics.

### EXAMPLES

Now, the present invention will be described in detail with reference to Examples, but it should be understood that the present invention is by no means thereby restricted. Ex. 1 to 6, and 8 to 11 are Examples of the present invention, and Ex. 7 and 12 are Comparative Examples.

### Particle Size

The hydroxide or the cathode active material was sufficiently dispersed in water by ultrasonic treatment, and the measurement was conducted by a laser diffraction/scattering type particle size distribution measuring apparatus (MT-3300EX manufactured by NIKKISO CO., LTD.), to obtain the frequency distribution and accumulative volume distribution curve, whereby the volume-based particle size distribution was obtained. From the obtained accumulative volume distribution curve, D₅₀ was obtained.

### Specific Surface Area

The specific surface area of the hydroxide or the cathode active material was calculated by a nitrogen adsorption BET method using a specific surface area measuring apparatus (HM model-1208, manufactured by Mountech Co., Ltd.). Degassing was carried out at 200° C. for 20 minutes.

### Composition Analysis

Composition analysis of the lithium-containing composite oxide was carried out by a plasma emission spectroscope (SPS3100H manufactured by SII NanoTechnology Inc.). From the ratio of the molar amounts of Li, Ni, Co and Mn obtained from the composition analysis, a, α, β and γ in aLi(Li_{1/3}Mn_{2/3})O₂·(1-a)LiNi_{α}Co_{β}Mn_{γ}O₂ were calculated.

### X-ray Diffraction

The X-ray diffraction of the lithium-containing composite oxide was measured by means of an X-ray diffraction apparatus (manufactured by Rigaku Corporation, apparatus name: SmartLab). The measurement conditions are shown in Table 1. The measurement was carried out at 25° C. Before the measurement, 1 g of the lithium-containing composite oxide and 30 mg of standard sample 640d for X-ray diffraction were mixed in an agate mortar, and this mixture was used as the sample for the measurement. With respect to the obtained X-ray diffraction pattern, peak search was carried out using integrated X-ray powder diffraction software PDXL2 manufactured by Rigaku Corporation. From the respective peaks, D₀₀₃, D₁₁₀, H₀₂₀, H₀₀₃ and W₀₂₀ were obtained.

TABLE 1

| Apparatus | Measurement | SmartLab manufactured | |
|---|---|---|---|
| condition | apparatus | by Rigaku Corporation | |
| | Target | Cu | |
| | Detector | D/teX Ultra HE manufactured | |
| | | by Rigaku Corporation | |
| | Detector baseline | 44 | div |
| | Detector window | 8 | div |
| | Gonio length | 300 | mm |
| | Soller/PSC | 5.0 | (deg.) |
| | IS long dimension | 10 | (mm) |
| | PSA | Open | |
| | Soller | 5.0 | (deg.) |
| | Monochromatization | Kβ filter method | |
| | method | | |
| Sample | Sample holder | Diameter: 24 mm, | |
| condition | | depth: 0.5 mm | |
| | Rotation of sample | Rotated (30 rpm) | |
| | during measurement | | |
| Measurement | Measurement method | General purpose measurement | |
| condition | | (focal method) | |
| | Scanning axis | 2θ/θ | |
| | Mode | Continuous | |
| | Range specification | Absolute | |
| | Initiation (deg.) | 15 | (deg.) |
| | Termination (deg.) | 75 | (deg.) |
| | Step (deg.) | 0.0052 | (deg.) |
| | Speed measurement | 1 | (deg./min.) |
| | time | | |
| | IS (deg.) | 1/3 | (deg.) |
| | RS1 (mm) | 8 | (mm) |
| | RS2 (mm) | 13 | (mm) |
| | Attenuator | Open | |
| | Tube voltage (kV) | 45 | (kV) |
| | Tube current (mA) | 200 | (mA) |

| | | |
|---|---|---|
| Data | Analysis software | PDXL2 manufactured |
| processing | | by Rigaku Corporation |
| condition | Smoothing | Smoothing by B-Spline, χ |
| | | threshold: 1.50 |
| | Background removal | Fitting |
| | Kα2 removal | Intensity ratio: 0.4970 |
| | Peak search | Secondary differentiation σ |
| | | cut: 3.00 |
| | Profile fitting | Fitting of measurement data |
| | Peak shape | Variance pseudo-voigt function |

### Production of Positive Electrode Sheet

The cathode active material obtained in each Ex., acetylene black as an electrically conductive material and polyvinylidene fluoride as a binder were weighed in a mass ratio of 80:10:10, and they were added to N-methylpyrrolidone to prepare a slurry.

The slurry was applied on one side of an aluminum foil as a positive electrode current collector having a thickness of 20 μm by means of a doctor blade. The gap of the doctor blade was adjusted so that the thickness of the sheet after roll pressing would be 30 μm. After drying at 120° C., roll pressing was carried out twice to prepare a positive electrode sheet.

### Production of Lithium Secondary Battery

One having the positive electrode sheet punched out in a circular shape with a diameter of 18 mm, was used as a positive electrode.

On one side of a stainless steel plate having a thickness of 1 mm as a negative electrode current collector, a metal lithium foil having a thickness of 500 μm was formed and used as a negative electrode.

As a separator, a porous polypropylene having a thickness of 25 μm was used.

As an electrolytic solution, a liquid having LiPF₆ dissolved at a concentration of 1 mol/dm³ in a solvent mixture of ethylene carbonate and diethyl carbonate in a volume ratio of 1:1, was used.

Using the above positive electrode, negative electrode, separator and aqueous electrolytic solution, a stainless steel simple sealed cell type lithium secondary battery was assembled in an argon globe box.

### Activation Treatment

With respect to the lithium secondary battery using the cathode active material in each of Ex. 1 to 7, constant current charging to 4.6V with a load current of 20 mA per 1 g of the cathode active material, followed by discharging to 2.0V with a load current of 200 mA per 1 g of the cathode active material, was repeated twice. Then, constant current charging was carried out to 4.7V with a load current of 200 mA per 1 g of the cathode active material, followed by constant voltage charging until the load current became 1 mA per 1 g of the cathode active material. Thereafter, discharging was carried out to 2.0V with a load current of 20 mA per 1 g of the cathode active material. The sum of the irreversible capacities at the first two times and the charge capacity at the last charging, was taken as the initial charge capacity, and the discharge capacity at the last discharging was taken as the initial discharge capacity.

With respect to the lithium secondary battery using the cathode active material in each of Ex. 8 to 12, constant current charging was carried out to 4.6V with a load current of 20 mA per 1 g of the cathode active material, followed by constant voltage charging until the load current became 1 mA per 1 g of the cathode active material. Thereafter, discharging was carried out to 2.0V with a load current of 20 mA per 1 g of the cathode active material. The charge capacity and the discharge capacity at the charging and the discharging were measured.

### Cycle Test

With respect to the activation-treated lithium secondary battery, constant current charging was carried out to 4.6V with a load current of 200 mA per 1 g of the cathode active material, followed by constant voltage charging at 4.6 V until the load current became 1.4 mA per 1 g of the cathode active material. Thereafter, discharging was carried out to 2.0V with a load current of 200 mA per 1 g of the cathode active material.

Such a charge and discharge cycle was repeated in a total of 50 times. The cycle retention rate (%) was obtained by the following formula, from the discharge capacity in the 2nd cycle and the discharge capacity in the 50th cycle.

Cycle retention rate (%)=Discharge capacity in 50th cycle/discharge capacity in 2nd cycle×100

### Ex. 1

Nickel(II) sulfate hexahydrate and manganese(II) sulfate pentahydrate were dissolved in distilled water so that the molar ratio of Ni and Mn would be as shown in Table 2 and the total amount of the sulfates would be 1.5 mol/kg to obtain an aqueous sulfate solution.

As a pH adjusting solution, sodium hydroxide was dissolved in distilled water so that the concentration would be 1.5mol/kg to obtain an aqueous sodium hydroxide solution.

As a complexing agent, ammonium sulfate was dissolved in distilled water so that the concentration would be 1.5 mol/kg to obtain an aqueous ammonium sulfate solution.

### Step (a)

Into a 2 L baffle-equipped glass reactor, distilled water was put and heated to 50° C. by a mantle heater. While stirring the liquid in the reactor by a paddle type stirring blade, the aqueous sulfate solution was added at a rate of 5.0 g/min and the aqueous ammonium sulfate solution was added at a rate of 0.5 g/min, for 14 hours, and the pH adjusting solution was added to maintain the pH of the mixed solution to be 11, to precipitate hydroxides containing Ni and Mn. During the addition of the raw material solutions, nitrogen gas was made to flow at a rate of 1.0 L/min in the reactor. Further, a liquid containing no hydroxide was continuously withdrawn using filter cloth, so that the liquid amount in the reactor would not exceed 2L. In order to remove impurity ions from the obtained hydroxides, pressure filtration and dispersion in distilled water were repeated for washing. Washing was completed at a point where the electrical conductivity of the filtrate became 20 mS/m, and the hydroxides were dried at 120° C. for 15 hours.

### Step (b)

The hydroxides and lithium carbonate were mixed so that the ratio in molar amount of Li to M (M is Ni and Mn) (i.e. Li/X₂) would be 1.50, to obtain a mixture.

In an electric furnace, while supplying air, the mixture was subjected to temporary firing at 600° C. in air over a period of 5 hours to obtain a temporarily fired product.

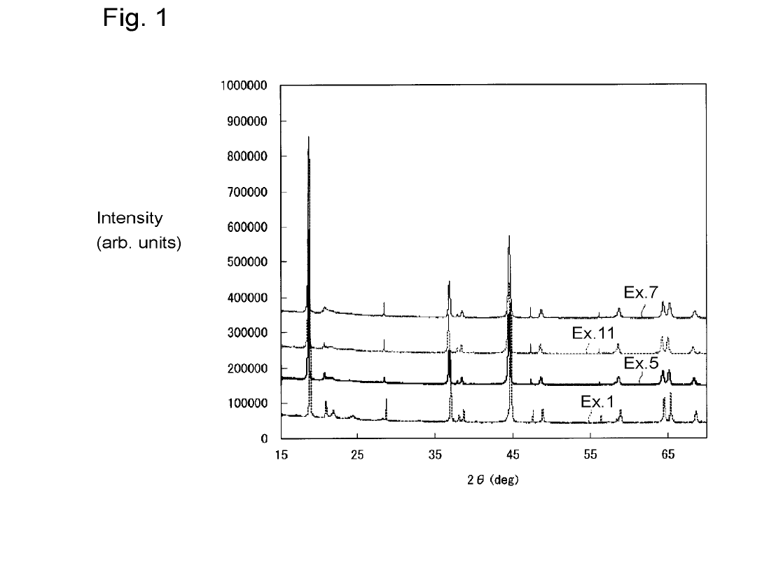

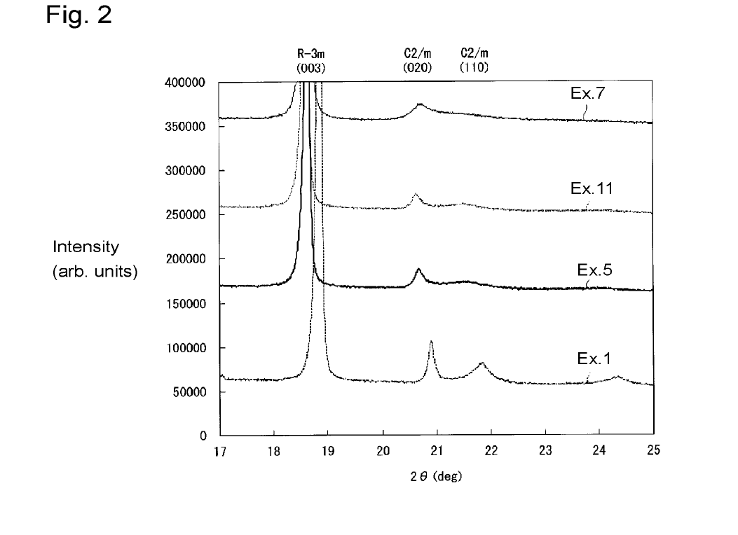

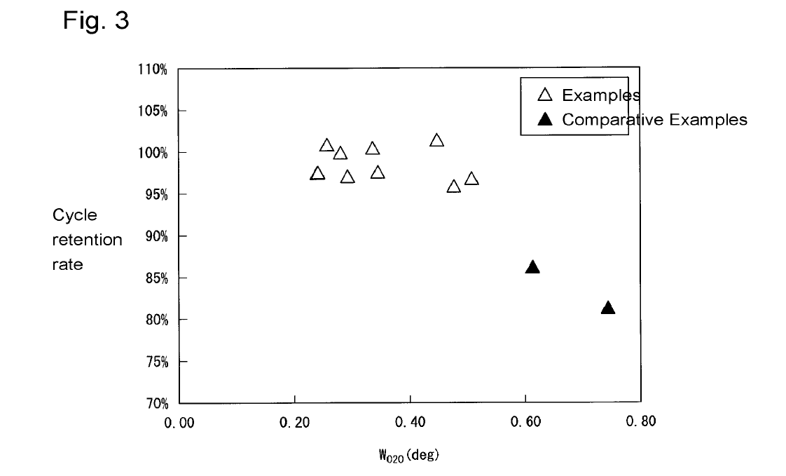

In an electric furnace, while supplying air, the temporarily fired product was subjected to main firing at 1,000° C. in air over a period of 16 hours to obtain a lithium-containing composite oxide. This lithium-containing composite oxide was used as a cathode active material. The results are shown in Tables 2, 3 and 4. The X-ray diffraction pattern of the cathode active material is shown in FIG. 1 and FIG. 2. The relation between W₀₂₀ and the cycle retention rate is shown in FIG. 3.

### Ex. 2 to 12

Lithium-containing composite oxides in Ex. 2 to 12 were obtained in the same manner as in Ex. 1 except that the conditions were changed as shown in Tables 2 and 3. The lithium-containing composite oxides were used as cathode active materials. The results are shown in Tables 2, 3 and 4. The X-ray diffraction patterns of the cathode active materials in Ex. 5, 7 and 11 are shown in FIG. 1 and FIG. 2. The relation between W₀₂₀ and the cycle retention rate in Ex. 2 to 12 is shown in FIG. 3.

TABLE 2

| | | | | | | | | | | Hydroxide | |
|---|---|---|---|---|---|---|---|---|---|---|---|
| | Step (a) | | | | | | | | | | Specific |
| | Charge [mol %] | | | Complexing agent | | Initial | Controlled | Time | Temp. | D₅₀ | surface area |
| Ex. | Ni | Co | Mn | Type | NH₄/X₂ | pH | pH | [hr] | [° C.] | [μm] | [m²/g] |
| 1 | 25.00 | 0.00 | 75.00 | Ammonium sulfate | 0.10 | 7 | 11 | 14 | 50 | 4.7 | 37.1 |
| 2 | 25.00 | 0.00 | 75.00 | Ammonium sulfate | 0.10 | 10.5 | 10.5 | 13 | 50 | 7.0 | 39.5 |
| 3 | 25.00 | 0.00 | 75.00 | Ammonium sulfate | 0.10 | 10.5 | 10.5 | 13 | 50 | 7.0 | 39.5 |
| 4 | 25.00 | 0.00 | 75.00 | Ammonium sulfate | 0.07 | 10.5 | 10.5 | 28 | 50 | 7.3 | 25.3 |
| 5 | 25.00 | 0.00 | 75.00 | Ammonium sulfate | 0.05 | 10.5 | 10.5 | 21 | 50 | 9.5 | 23.6 |
| 6 | 25.00 | 0.00 | 75.00 | Ammonium sulfate | 0.05 | 10.5 | 10.5 | 10 | 50 | 8.0 | 24.8 |
| 7 | 25.00 | 0.00 | 75.00 | Ammonium sulfate | 0.10 | 10.5 | 10.5 | 13 | 50 | 7.0 | 39.5 |
| 8 | 30.00 | 0.00 | 70.00 | Aqueous ammonia | 0.10 | 10.5 | 10.5 | 28 | 50 | 6.7 | 18.0 |
| 9 | 30.00 | 0.00 | 70.00 | Aqueous ammonia | 0.10 | 10.5 | 10.5 | 28 | 50 | 6.7 | 18.0 |
| 10 | 30.00 | 0.00 | 70.00 | Ammonium sulfate | 0.10 | 10.5 | 10.5 | 28 | 50 | 5.5 | 25.9 |
| 11 | 30.00 | 0.00 | 70.00 | Ammonium sulfate | 0.10 | 10.5 | 10.5 | 28 | 50 | 5.5 | 25.9 |
| 12 | 30.00 | 0.00 | 70.00 | Ammonium sulfate | 0.10 | 10.5 | 10.5 | 28 | 50 | 5.5 | 25.9 |

TABLE 3

| | Step (b) | | | | | Cathode active material | | | | | | |
|---|---|---|---|---|---|---|---|---|---|---|---|---|
| | | Temporary | | Main | | (lithium-containing composite oxide) | | | | | | |
| | | firing | | firing | | Analyzed | | | | | | |
| | Charge | Temp. | Time | Temp. | Time | composition | | | aLi(Li_{1/3}Mn_{2/3})O₂•(1-a)LiNi_{α}Co_{β}Mn_{γ}O₂ | | | |
| Ex. | Li/X₂ | [° C.] | [hr] | [° C.] | [hr] | Ni/X | Co/X | Mn/X | a | α | β | γ |
| 1 | 1.500 | 600 | 5 | 1000 | 16 | 0.250 | 0.00 | 0.750 | 0.60 | 0.50 | 0.00 | 0.50 |
| 2 | 1.500 | 600 | 5 | 965 | 16 | 0.250 | 0.00 | 0.750 | 0.60 | 0.50 | 0.00 | 0.50 |
| 3 | 1.580 | 600 | 5 | 920 | 16 | 0.250 | 0.00 | 0.750 | 0.67 | 0.60 | 0.00 | 0.40 |
| 4 | 1.500 | 600 | 5 | 935 | 16 | 0.250 | 0.00 | 0.750 | 0.60 | 0.50 | 0.00 | 0.50 |
| 5 | 1.500 | 600 | 5 | 935 | 16 | 0.249 | 0.00 | 0.751 | 0.60 | 0.50 | 0.00 | 0.50 |
| 6 | 1.580 | 600 | 5 | 935 | 16 | 0.250 | 0.00 | 0.750 | 0.67 | 0.60 | 0.00 | 0.40 |
| 7 | 1.620 | 600 | 5 | 890 | 16 | 0.250 | 0.00 | 0.750 | 0.71 | 0.66 | 0.00 | 0.34 |
| 8 | 1.400 | 600 | 5 | 900 | 16 | 0.300 | 0.00 | 0.700 | 0.50 | 0.50 | 0.00 | 0.50 |
| 9 | 1.400 | 600 | 5 | 955 | 16 | 0.300 | 0.00 | 0.700 | 0.50 | 0.50 | 0.00 | 0.50 |
| 10 | 1.400 | 600 | 5 | 895 | 16 | 0.298 | 0.00 | 0.702 | 0.50 | 0.50 | 0.00 | 0.50 |
| 11 | 1.400 | 600 | 5 | 920 | 16 | 0.298 | 0.00 | 0.702 | 0.50 | 0.50 | 0.00 | 0.50 |
| 12 | 1.400 | 600 | 5 | 855 | 16 | 0.299 | 0.00 | 0.701 | 0.50 | 0.50 | 0.00 | 0.50 |

TABLE 4

| | Cathode active material (lithium-containing composite oxide) | | | | | | Lithium secondary battery | | |
|---|---|---|---|---|---|---|---|---|---|
| | | Specific | | | | | Charge | Discharge | Cycle |
| | D₅₀ | surface | | | | | capacity | capacity | retention |
| Ex. | [μm] | area [m²/g] | D₀₀₃ [nm] | D₁₁₀ [nm] | H₀₂₀/H₀₀₃ | W₀₂₀ [deg] | [mAh/g] | [mAh/g] | rate [%] |
| 1 | 4.4 | 2.17 | 84.0 | 60.5 | 0.0629 | 0.2405 | 336.2 | 257.7 | 97.5 |
| 2 | 6.7 | 2.71 | 76.8 | 51.5 | 0.0558 | 0.2420 | 344.9 | 278.9 | 97.5 |
| 3 | 6.6 | 2.84 | 65.6 | 28.9 | 0.0330 | 0.4767 | 358.4 | 281.4 | 95.9 |
| 4 | 7.0 | 1.87 | 72.4 | 41.8 | 0.0469 | 0.2576 | 331.0 | 262.5 | 100.9 |
| 5 | 9.2 | 1.65 | 71.5 | 35.1 | 0.0484 | 0.2809 | 319.5 | 240.3 | 99.9 |
| 6 | 7.7 | 2.23 | 70.1 | 31.4 | 0.0345 | 0.5076 | 355.5 | 278.9 | 96.8 |
| 7 | 6.6 | 2.71 | 63.9 | 25.9 | 0.0297 | 0.6131 | 364.7 | 251.1 | 86.2 |
| 8 | 6.8 | 0.70 | 62.8 | 28.8 | 0.0348 | 0.4476 | 314.6 | 226.1 | 101.4 |
| 9 | 6.7 | 0.71 | 70.3 | 35.1 | 0.0348 | 0.3456 | 317.9 | 243.3 | 97.6 |
| 10 | 5.7 | 2.32 | 68.8 | 33.7 | 0.0349 | 0.3366 | 318.9 | 260.2 | 100.5 |
| 11 | 5.4 | 2.04 | 73.7 | 38.4 | 0.0377 | 0.2931 | 313.6 | 262.7 | 97.1 |
| 12 | 5.5 | 1.75 | 51.4 | 18.0 | 0.0272 | 0.7434 | 308.4 | 243.9 | 81.3 |

The lithium secondary batteries using the cathode active materials in Ex. 1 to 6 and 8 to 11 wherein W₀₂₀ was at most 0.55 deg, were excellent in the cycle characteristics.

The lithium secondary batteries using the cathode active materials in Ex. 7 and 12 wherein W₀₂₀ exceeded 0.55 deg, were inferior in the cycle characteristics.

### INDUSTRIAL APPLICABILITY

By the cathode active material of the present invention, it is possible to obtain a lithium ion secondary battery excellent in the discharge capacity and cycle characteristics.

The entire disclosure of Japanese Patent Application No. 2015-011027 filed on January 23, 2015 including specification, claims, drawings and summary is incorporated herein by reference in its entirety.

What is claimed is:

1. A cathode active material comprising a lithium-containing composite oxide,
wherein the lithium-containing composite oxide is represented by aLi(Li_{1/3}Mn_{2/3})O₂·(1-a)LiMO₂ (wherein M is at least one transition metal element selected from Ni, Co and Mn, and a is more than 0 and less than 1), and in an X-ray diffraction pattern of the lithium-containing composite oxide, the integral breadth of a peak of (020) plane assigned to a crystal structure with space group C2/m is at most 0.55 deg.

2. The cathode active material according to claim 1, wherein in the lithium-containing composite oxide, the ratio of the molar amount of Ni to the total molar amount (X) of Ni, Co and Mn (i.e. Ni/X) is from 0.15 to 0.45, the ratio of the molar amount of Co thereto (i.e. Co/X) is from 0 to 0.09, and the ratio of the molar amount of Mn thereto (i.e. Mn/X) is from 0.55 to 0.85.

3. The cathode active material according to claim 1, wherein the specific surface area of the cathode active material is from 0.5 to 4 m²/g.

4. The cathode active material according to claim 1, wherein D₅₀ of the cathode active material is from 3 to 15 μm.

5. The cathode active material according to claim 1, wherein in an X-ray diffraction pattern of the lithium-containing composite oxide, the crystallite diameter obtained by the Scherrer equation from a peak of (003) plane assigned to a crystal structure with space group R-3m is from 30 to 120 nm.

6. The cathode active material according to claim 1, wherein in an X-ray diffraction pattern of the lithium-containing composite oxide, the crystallite diameter obtained by the Scherrer equation from a peak of (110) plane assigned to a crystal structure with space group R-3m is from 10 to 80 nm.

7. A positive electrode for a lithium ion secondary battery, which comprises the cathode active material as defined in claim 1, an electrically conductive material and a binder.

8. A lithium ion secondary battery, which comprises the positive electrode for a lithium ion secondary battery as defined in claim 7, a negative electrode and a non-aqueous electrolyte.
